(19) United States
(12) Patent Application Publication
(10) Pub. No.: US 2010/0320296 A1
(43) Pub. Date: Dec. 23, 2010

(54) Coal Gasification Burner

(75) Inventors: Hanno Tautz, Geretsried (DE); Johann Ferstl, Muenchen (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: LINDE AKTIENGESELLSCHAFT, Muenchen (DE)

(21) Appl. No.: 12/818,741

(22) Filed: Jun. 18, 2010

(30) Foreign Application Priority Data
Jun. 20, 2009 (DE) 102009025703.9

(51) Int. Cl. B05B 15/00

(52) U.S. Cl. 239/591

(57) ABSTRACT

The invention relates to a burner with a burner head and burner tubes (A, I, Z), arranged in the burner head, which are made of metal and are intended for feeding at least one fuel (K) and an oxidizing agent (O) into a reaction space. At least one of the burner tubes (I) is provided with a cladding (V) which is composed of a ceramic material and entirely or partially covers the inner or the outer surface of the burner tube so that hot gas corrosion and mechanical abrasion are avoided. In order to minimize the mechanical loads acting on the cladding, the ceramic cladding (V) is connected to the metallic burner tube (I) by means of a form-fitting connection.

### SUMMARY OF THE INVENTION

The invention relates'to a burner with a burner head and burner tubes which are arranged in the burner head, are made of metal and are intended for feeding at least one fuel and an oxidizing agent into a reaction space, wherein at least one of the burner tubes is provided with a cladding which is composed of a ceramic material and entirely or partially covers the inner or the outer surface of the burner tube.

Burners of this type are used, for example, in the production of synthesis gas in order to introduce a coal slurry and an oxidizing agent via separate feed channels into a reaction space to convert them there by means of partial oxidation. The conversion typically takes place at a pressure of between 1 and approx. 80 bar, and flame temperatures of 1200-2000° C. are reached.

According to the prior art, the service life of the burners under these operating conditions is only a few months, since said burners are subjected to high thermal loading and the coal slurry in the feed channels causes heavy abrasion of the material. When air is used as oxidizing agent, the burners are customarily cooled by the sucked-in air. If technically pure oxygen or oxygen-enriched air is used, the cooling is generally performed by means of cooling water. For this purpose, the burner generally has a cooling channel on the end side thereof and can be supplied with cooling water via a cooling water coil which is welded on. Said cooling coil tends to fracture and therefore constitutes another weak point of a burner of this type.

European Patent Specification EP 0 868 394 B1 (See also U.S. Pat. No. 5,931,978) describes a gas-cooled burner with at least one metallic burner tube which has a ceramic ring at the reaction-space end thereof in order to protect it from excessive thermal loading. The patent specification indicates that the ceramic ring is connected to the metallic parts of the burner tubes by means of welding. Experience has shown that a welding connection between ceramic and metal is problematic and, particularly at high temperatures, is not very durable.

European Patent Specification EP 0 312 133 B1 (See also U.S. Pat. No. 4,878,835) describes a gas-cooled burner which has a thin-walled casing tube which is composed of ceramic or is clad with ceramic. The casing tube surrounds and protects internal components, which form feed channels for fuel and oxidizing agent, and is connected in a gastight manner to that part of the burner head which is composed of metal, the intention being that a free thermal expansion of the parts is possible. The greater the pressure difference prevailing between the two sides of the casing tube, the more difficult is it for this requirement to be met and the more complicated the structural measures required.

Therefore, an aspect of the present invention is to provide a burner of the type in question which overcomes the disadvantages of the prior art.

This aspect can be achieved according to the invention by use of a ceramic cladding that is connected to the metallic burner tube by means of a form-fitting connection.

Upon further study of the specification and appended claims, further aspects and advantages of this invention will become apparent to those skilled in the art.

The form-fitting connection between the ceramic cladding and the metallic burner tube is preferably designed in such a manner that there is always play between the two parts during the operation of the burner. As a result, stresses due to different thermal expansions, which may easily result in damage, can be reliably avoided.

The ceramic cladding is expediently arranged in the burner head in such a manner that it is supported only on the metallic burner tube, and does not come into contact with the remaining parts of the burner head even under unfavorable operating conditions. In particular, the ceramic cladding does not take any part in the connection between the burner head and burner tube. Only the metallic part of the burner tube is involved in this connection, and therefore this connection can be designed to be long-lasting and also gas- and fluid-tight with little outlay.

The task of the ceramic cladding is to protect metallic parts of the burner in order to prolong the service life of the burner. The ceramic cladding is therefore expediently arranged at locations which are exposed to a high thermal and/or mechanical loading during the operation of the burner. By contrast, the cladding of locations which are less highly loaded is associated with additional costs without necessarily prolonging the service life of the burner. Since the reaction-space ends of the burner tubes are customarily subjected to a higher loading than the opposite, cold ends thereof, in a preferred embodiment of the burner according to the invention the ceramic cladding is arranged at the reaction-space end of the burner tube and extends in the longitudinal direction only over part of the burner tube length. In this case, the ceramic cladding can end flush with the burner tube or can extend past the burner tube.

The ceramic cladding is preferably composed of one piece and is designed as a sleeve which can be arranged in the interior or on the outer side of the burner tube. The ceramic cladding can be composed of any ceramic which is resistant under the conditions occurring during the use of the burner. However, it is preferably composed of silicon nitrite, silicon carbide or aluminum oxide.

The ceramic cladding reduces the thermal loading to which the burner tube tip is subjected during the operation of the burner. Furthermore, it protects the metallic material of the burner tube against mechanical attacks such as occur, for example, if solid particles are introduced into the reaction space via the burner tube. Reaction burners which are used in the partial oxidation of coal are subjected to particularly high loading, the coal being introduced in the form of coal slurry or coal dust via one or more burner tubes as feed channels into a reaction space. Therefore, in a preferred refinement of the invention, the ceramic cladding bounds a feed channel through which coal slurry or coal dust can be introduced as fuel into the reaction space.

The use of burner tubes which are not very susceptible to the form of corrosion referred to as metal dusting and which therefore have a high degree of resistance particularly under the conditions which occur during partial oxidation has been tried and tested in the past. Therefore, in a further preferred refinement of the burner according to the invention, one or more of the burner tubes of the burner is composed, at least at the reaction-space ends thereof, of a metal alloy which is resistant to metal dusting, in particular of an iron alloy which is resistant to corrosion under high temperatures and, for example, contains aluminum.

The invention is particularly suitable for use in burners, the burner tubes of which have circular cross sections and which are arranged concentrically with respect to one another. However, the use of the invention is not restricted to burners of this type.

In principle, a burner according to the invention can be used in a multiplicity of applications. However, it can be used particularly advantageously as a reaction burner in an apparatus in which carbon-containing materials are converted by partial oxidation into a synthesis gas which contains carbon monoxide and hydrogen as the main components.

### BRIEF DESCRIPTION OF THE DRAWINGS

The invention and further details, such as features and attendant advantages, of the invention are explained in more detail below on the basis of the exemplary embodiments which are diagrammatically depicted in the drawings, and wherein:

FIG. 1 schematically illustrates an exemplary embodiment.

The exemplary embodiment illustrates a part of the burner head of a reaction burner, via which coal slurry can be fed as fuel and temperature moderator, and oxygen can be fed as oxidizing agent to a reaction space in order to be converted there by means of partial oxidation.

The burner head comprises the three concentrically arranged burner tubes A, I and Z which each have a circular cross section. Oxygen O can be introduced via the feed channel, which is formed by the outer burner tube A and the inner burner tube I, and via the central burner tube Z into the reaction space (not illustrated) which is placed downstream, while the feed channel formed by the inner burner tube I and the central burner tube Z is provided for the feeding in of the coal slurry K. During the operation of the burner, the reaction-space end of the inner burner tube I is exposed to a severe thermal loading, since it is only relatively weakly cooled by the stream of oxygen. In order to avoid damage to the inner burner tube I, the latter has an end piece E which is composed of a metal alloy which has, for example, a high degree of resistance to metal dusting. The inner side of the inner burner tube I is provided with a ceramic cladding V which in particular protects the end piece E against the mechanical stresses caused by the coal slurry. The ceramic cladding V, which is composed of an abrasion-resistant material, such as silicon carbide or silicon nitrite, is designed in the form of a sleeve which is connected in a form-fitting manner to the inner burner tube I. As shown, the ceramic cladding V extends past the end of inner burner tube I. Alternatively, the ceramic cladding V can end flush with inner burner tube I.

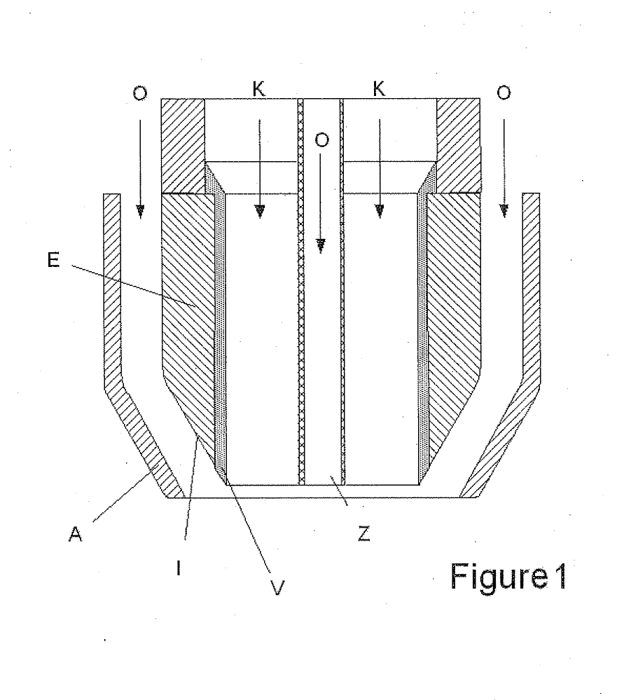

FIG. 1 illustrates one embodiment of the form-fitting connection between the ceramic cladding and a metallic burner tube. As shown in the Figure, the end piece E of the inner burner tube I has a smaller inner diameter than the portion of inner burner tube I adjacent end piece E. This results in the formation of a ledge on the inner surface of inner burner tube I. Conversely, the upper portion of ceramic cladding V has a greater outside diameter than the portion of ceramic cladding V adjacent the upper portion thereby forming a rim upper portion of ceramic cladding V. In making form-fitting connection the rim of the upper portion of ceramic cladding V contacts the ledge on the inner surface of inner burner tube I.

The entire disclosure[s] of all applications, patents and publications, cited herein and of corresponding German Application No. DE 102009025703.9, filed Jun. 20, 2010 are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A burner comprising a burner head and burner tubes (A, I, Z) arranged in said burner head,
wherein said burner tubes are made of metal and are intended for feeding at least one fuel (K) and an oxidizing agent (O) into a reaction space,
at least one of said burner tubes (I) is provided with a cladding (V) which is composed of a ceramic material and entirely or partially covers the inner or the outer surface of said at least one burner tube, and
said ceramic cladding (V) is connected to said at least one burner tube (I) by means of a form-fitting connection.

2. The burner according to claim 1, wherein said ceramic cladding (K) extends past said at least one burner tube (I) at the reaction-space end thereof.

3. The burner according to either Claim 1, wherein said ceramic cladding (V) is designed as a sleeve.

4. The burner according to Claim 1, wherein said ceramic cladding (V) is composed of silicon nitrite, silicon carbide, aluminum oxide.

5. The burner according to Claim 1, wherein said ceramic cladding (V) bounds a feed channel through which coal slurry (K) can be introduced as fuel into a reaction space.

6. The burner according to any one of Claim 1, wherein one or more of said burner tubes (I) is composed, at least at the reaction-space ends thereof, of an iron alloy which is resistant to corrosion under high temperatures.

7. The burner according to Claim 1, wherein said burner tubes (A, I, Z) are arranged concentrically with respect to one another.
